(19) United States
(12) Patent Application Publication
(10) Pub. No.: US 2018/0271135 A1
(43) Pub. Date: Sep. 27, 2018

(54) GENDER SPECIFIC SYNTHETIC NUTRITIONAL COMPOSITIONS AND NUTRITIONAL SYSTEMS COMPRISING THEM

(71) Applicant: NESTEC S.A., Vevey (CH)

(72) Inventors: Sagar Thakkar, Brent (CH); Michael Affolter, Savigny (CH); Carlos Antonio De Castro, Geneva (CH)

(21) Appl. No.: 15/763,192

(22) PCT Filed: Sep. 28, 2015
(86) PCT No.: PCT/CN2015/090939

§ 371 Date: Mar. 26, 2018

(51) Int. Cl. A23L 33/175; A23L 33/00

(52) U.S. Cl. CPC A23L 33/175; A23V 2002/00; A23L 33/40

(57) ABSTRACT

Gender specific synthetic nutritional compositions comprising glycine in concentrations reflecting those found in human milk produced by mothers of infants of the corresponding gender at the corresponding stage of lactation, and nutritional systems comprising them.

### TECHNICAL FIELD

The invention relates to gender specific synthetic nutritional compositions, to nutritional systems comprising them, and to their use to provide an optimised amount of glycine and/or one or more health benefit to an infant.

### BACKGROUND OF THE INVENTION

Even though breastfeeding is optimal for infants, the existence of certain conditions may mean that it is contraindicated (AAP, 2012; Lawrence, 2013). In such cases, where the sole source of nutrition is not available to infants, alternative strategies to feed them have to be devised. Feeding infants with synthetic nutritional compositions e.g. Infant formula is one such strategy.

The compositions of the aforementioned synthetic nutritional compositions e.g. infant formulas, aim to replicate those of human milk (hereinafter HM). However, replicating HM is not a simple task. HM not only contains numerous components, its composition is extremely dynamic and these dynamic changes remain largely unexplored and uncharacterized.

The inventors have now surprisingly found that the concentration of glycine in HM may differ depending on the stage of lactation and the gender of a mother's infant. Because such age and gender differences in the glycine concentration of HM have never previously been identified, these differences are not reflected in the compositions of synthetic nutritional compositions available for infants today. Given that HM is considered the gold standard with respect to infant nutrition, there remains a need for synthetic nutritional compositions tailored for infants of specific ages and genders which better reflect these identified differences.

### SUMMARY OF THE INVENTION

The invention is set out in the claims. The inventors have developed gender specific synthetic nutritional compositions for infants comprising glycine in concentrations that reflect the concentration of glycine found in HM produced for an infant of the same age and gender.

Said gender specific synthetic nutritional compositions may for example be an infant formula or a composition for an infant that is intended to be added to or diluted with human milk e.g. human milk fortifier.

The gender specific synthetic nutritional compositions of the invention can be prepared from a gender neutral synthetic nutritional composition by measuring out an appropriate amount of said gender neutral synthetic nutritional composition and mixing it with an additive and/or diluent e.g. glycine and/or water.

The gender specific synthetic nutritional compositions of the invention may be included in a nutritional system. Said nutritional system may comprise a gender specific synthetic nutritional composition for a female infant and/or a gender specific composition for a male infant of the same age. A gender specific synthetic nutritional composition for a female infant of 1 to 2 months of age may comprise more glycine than a gender specific synthetic nutritional composition for a male infant of the same age, whereas a gender specific synthetic nutritional composition for a female infant of up to 1 months of age, or older than 2 months of age may comprise less glycine than a gender specific synthetic nutritional composition for a male infant of the same age.

The glycine concentration of a gender specific synthetic nutritional composition of the invention reflects the glycine concentration found in HM produced for an infant of the same gender and age. Because HM is considered optimal with respect to infant nutrition, a gender specific synthetic nutritional composition of the invention, and therefore a nutritional system comprising same, may provide an optimized amount of glycine to an infant, and may be used to ensure optimum glycine levels in an infant.

Said gender specific synthetic nutritional compositions of the invention, and the nutritional systems comprising them, may help to ensure optimum growth and development.

### DRAWINGS

FIG. 1 is a graphical representation of the glycine concentration in HM by gender at 5-11 days, 12-30 days, 1-2 months, 2-4 months and 4-8 months postpartum.

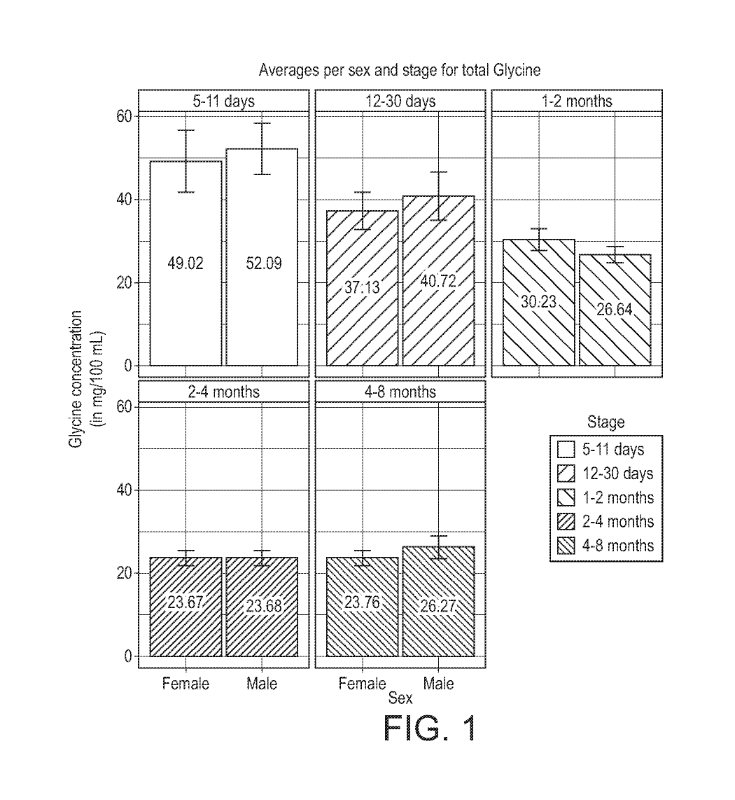

### DETAILED DESCRIPTION

The inventors performed a cross sectional study evaluating the nutrient composition of HM collected from mothers at various stages of lactation (up to 2 weeks (5-11 days), 2 weeks to 1 month (12-30 days), 1 to 2 months (31 to 60 days), 2 to 4 months (61 to 120 days) and, 4 to 8 months (121 to 240 days) postpartum). Surprisingly the results of this study indicated that the concentration of glycine found in HM can differ depending on the stage of lactation and/or the gender of a mother's infant. In particular this study indicated that the concentration of glycine may be higher in HM produced by mothers to girls (females) than in HM produced by mothers to boys (males) at 1 to 2 months postpartum, whilst up to 1 month postpartum and after 2 months postpartum the concentration of glycine may be lower in HM produced by mothers to girls (females) than in HM produced by mothers to boys (males). Details of the study, analysis techniques and results are given in example 1.

Based on the findings of the study, the inventors have designed gender specific synthetic nutritional compositions that comprise glycine in a concentration that reflects the glycine concentration found in HM produced for an infant of the same gender at the corresponding stage of lactation.

The term “gender specific synthetic nutritional composition” as used herein refers to any synthetic nutritional composition, intended to be consumed by an infant that is specifically adapted to the nutritional needs of either a female or male enfant. Non limiting examples of gender specific synthetic nutritional compositions for infants from birth to 4 months include; infant formulae, and a composition for infants that is intended to be added or diluted with HM e.g. HM fortifier. Non limiting examples of gender specific synthetic nutritional compositions for infants from 4 months to 12 months include infant formulae, a composition for infants that is intended to be added or diluted with HM e.g. HM fortifier, or food stuffs intended for consumption by infants either alone or in combination with HM e.g. complementary foods.

The term “infant” as used herein refers to a human infant of 12 months of age or less.

In an aspect of the present invention there is provided a gender specific synthetic nutritional composition tailored for an infant comprising glycine in a concentration reflecting the concentration found in HM produced for an infant of the same gender at the corresponding lactation stage i.e. age.

In an embodiment the gender specific synthetic nutritional composition is a female gender specific synthetic nutritional composition for an infant of up to 1 month of age and comprises glycine in a concentration selected from the group consisting of: 16 to 152, 25 to 90, 34 to 50, 34 to 49, 38 to 46, 37 to 49.5 mg/100 mL.

In an embodiment the gender specific synthetic nutritional composition is a male gender specific synthetic nutritional composition for an infant of up to 1 month of age, and comprises glycine in a concentration selected from the group consisting of 18 to 157, 20 to 155, 29 to 97, 36 to 82, 40 to 53, 40 to 52.5 mg/100 mL.

Non limiting examples of ages up to 1 months of age include; up to 2 weeks (more particularly 5 to 11 days), up to 1 month.

In an embodiment the gender specific synthetic nutritional composition is a female gender specific synthetic nutritional composition for an infant of 1 to 2 months of age and comprises glycine in a concentration selected from the group consisting of: 17 to 54, 21 to 47, 30 to 39, 28 to 30.5, 28.3 to 30.23 mg/100 mL.

In an embodiment the gender specific synthetic nutritional composition is a male gender specific synthetic nutritional composition for an infant of 1 to 2 months of age and comprises glycine in a concentration selected from the group consisting of: 15 to 45, 19 to 40, 33 to 27, 26 to 27 mg/100 mL.

Non limiting examples of ages 1 months to 2 months include; 1 month, 2 months, 1 month up to 2 months.

In an embodiment the gender specific synthetic nutritional composition is a female gender specific synthetic nutritional composition for an infant from 2 months of age and comprises glycine in a concentration selected from the group consisting of: 13 to 42, 17 to 36, 22 to 30, 22 to 24 mg/100 mL.

In an embodiment the gender specific synthetic nutritional composition is a male gender specific synthetic nutritional composition for an infant from 2 months of age and comprises glycine in a concentration selected from the group consisting of: 8 to 77, 13 to 46, 18 to 35, 19 to 29, 23 to 26 mg/100 mL.

Non limiting examples of an age from 2 months of age; 3, 4, 5, 6, 7, 8, 9, 10, 11, and 12 months of age, 3 to 6 months of age, 4 to 8 months of age, 4 to 12 months of age, 6 to 12 months of age, 6 to 9 months of age, and 9 to 12 months of age.

The glycine concentration of the gender specific synthetic nutritional compositions defined herein is expressed in mg/100 mL. This may refer to the glycine concentration of a reconstituted gender specific synthetic nutritional composition.

The term glycine as used herein refers to total concentration of glycine whether in the d or L form, and/or whether free or bound i.e. protein bound.

The glycine protein source may be intact, hydrolysed, partially hydrolysed, or any combination thereof.

The glycine concentration of a composition can be measured by methods well known in the art. In particular the glycine concentration can be measured by an amino acid analyzer (using post-column derivatisation with ninhydrin) or by a pre-column derivatisation method (i.e. using PITC or OPA/FMOC chemistry as described in Blankenship D. T. et al. (1989) Analytical Biochemistry 178: 227) followed by HPLC separation and quantification

Any source of glycine suitable for administration to an infant to whom the gender specific synthetic nutritional composition is directed may be comprised within in the gender specific synthetic nutritional compositions of the invention. In particular, they may be pure synthetic amino acids obtained through synthesis or fermentation, or liberated from any food-grade protein source such as animal or plant proteins through hydrolysis. Particular sources of glycine may be gelatins, fish, egg or soy proteins.

The synthetic nutritional compositions of the invention can also comprise any other ingredients or excipients known to be employed in the type of gender specific synthetic nutritional composition in question e.g. infant formula.

Non limiting examples of such ingredients include: proteins, other amino acids, carbohydrates, oligosaccharides, lipids, prebiotics or probiotics, essential fatty acids, nucleotides, nucleosides, vitamins, minerals and other micronutrients.

Non limiting examples of proteins include: casein, alpha-lactalbumin, whey, soy protein, rice protein, corn protein, oat protein, barley protein, wheat protein, rye protein, pea protein, canola (rapeseed) protein, egg protein, sunflower seed protein, potato protein, fish protein, meat protein, lactoferrin, serum albumin, immunoglobins, and combinations thereof.

Non limiting examples of other amino acids include leucine, threonine, tyrosine, lsoleucine, arginine, alanine, histidine, isoleucine, proline, valine, cysteine, glutamine, glutamic acid, phenylalanine, serine, arginine, lysine, methionine, tryptophan, asparagine, aspartic acid, and combinations thereof.

Non limiting examples of carbohydrates include lactose, saccharose, maltodexirin, starch, and combinations thereof.

Non limiting examples of lipids include: palm olein, high oleic sunflower oil, high oleic safflower oil, canola oil, fish oil, coconut oil, bovine milk fat, and combinations thereof.

Non limiting examples of essential fatty acids include: linoleic acid (LA), α-linolenic acid (ALA) and polyunsaturated fatty acids (PUFAs). The gender specific synthetic nutritional compositions of the invention may further contain gangliosides monosialoganglioside-3 (GM3) and disialogangliosides 3 (GD3), phospholipids such as sphingomyelin, phospholipids phosphatidylcholine, phosphatidylethanolamine, phosphatidylinositol, phosphatidylserine, and combinations thereof.

None limiting examples of prebiotics include: oligosaccharides optionally containing fructose, galactose, mannose; dietary fibers, in particular soluble fibers, soy fibers; inulin; and combinations thereof. Preferred prebiotics are fructo-oligosaccharides (FOS), galacto-oligosaccharides (GOS), isomalto-oligosaccharides (IMO), xylo-oligosaccharides (XOS), arabino-xylo oligosaccharides (AXOS), mannan-oligosaccharides (MOS), oligosaccharides of soy, glycosylsucrose (GS), lactosucrose (LS), lactulose (LA), palatinose-oligosaccharides (PAO), malto-oligosaccharides, gums and/or hydrolysates thereof, pectins and/or hydrolysates thereof, and combinations of the foregoing.

Further examples of oligosaccharide are described in Wrodnigg, T. M.; Stutz, A. E. (1999) Angew. Chem. Int. Ed. 38:827-828 and in WO 2012/069416 which is incorporated herein by reference.

Non limiting examples of probiotics include: Bifidobacterium, Lactobacillus, Lactococcus, Enterococcus, Streptococcus, Kluyveromyces, Saccharoymces, Candida, in particular selected from the group consisting of Bifidobacterium longum, Bifidobacterium lactis, Bifidobacterium animalis, Bifidobacterium breve, Bifidobacterium infantis, Bifidobacterium adolescentis, Lactobacillus acidophilus, Lactobacillus casei, Lactobacillus paracasei, Lactobacillus salivarius, Lactobacillus lactis, Lactobacillus rhamnosus, Lactobacillus johnsonii, Lactobacillus plantarum, Lactobacillus salivarius, Lactococcus lactis, Enterococcus faecium, Saccharomyces cerevisiae, Saccharomyces boulardii or mixtures thereof, preferably selected from the group consisting of Bifidobacterium longum NCC3001 (ATCC BAA-999), Bifidobacterium longum NCC2705 (CNCM I-2618), Bifidobacterium longum NCC490 (CNCM 1-2170), Bifidobacterium lactis NCC2818 (CNCM I-3446), Bifidobacterium breve strain A, Lactobacillus paracasei NCC2461 (CNCM 1-2116), Lactobacillus johnsonii NCC533 (CNCM 1-1225), Lactobacillus rhamnosus GG (ATCC53103), Lactobacillus rhamnosus NCC4007 (CGMCC 1.3724), Enterococcus faecium SF 68 (NCC2768; NCIMB10415), and combinations thereof.

Non limiting examples of Nucleotides include: cytidine monophosphate (CMP), uridine monophosphate (UMP), adenosine monophosphate (AMP), guanosine monophosphate (GMP), and combinations thereof.

Non limiting examples of vitamins and minerals include: vitamin A, vitamin B1, vitamin B2, vitamin B3, vitamin B6, vitamin B9, vitamin B12, vitamin E, vitamin K, vitamin C, vitamin D, folic acid, inositol, niacin, biotin, pantothenic acid, choline, calcium, phosphorous, iodine, iron, magnesium, copper, zinc, manganese, chloride, potassium, sodium, selenium, chromium, molybdenum, taurine, L-carnitine, and combinations thereof. Minerals are usually added in salt form.

Other suitable and desirable ingredients of synthetic nutritional compositions, that may be employed in the gender specific synthetic nutritional compositions of the invention are described in guidelines issued by the Codex Alimentarius with respect to the type of synthetic nutritional composition in question e.g. Infant formula, HM fortifier, follow on formula, or food stuffs intended for consumption by infants e.g. complementary foods.

The gender specific synthetic nutritional compositions of the invention may be prepared by methods well known in the art for preparing the type of gender specific synthetic nutritional composition in question e.g. infant formulae, follow on formulae, a composition for infants that is intended to be added or diluted with HM e.g. HM fortifier, or food stuffs intended for consumption by infants either alone or in combination with HM e.g. complementary foods.

An exemplary method for preparing a gender specific powdered infant formula is as follows. Amino acids (including glycine), and/or a protein source (optionally comprising bound glycine, a carbohydrate source, and a fat source may be blended together in appropriate proportions. Emulsifiers may be included in the blend. Vitamins and minerals may be added at this point but are usually added later to avoid thermal degradation. Any lipophilic vitamins, emulsifiers and the like may be dissolved into the fat source prior to blending. Water, preferably water which has been subjected to reverse osmosis, may then be mixed in to form a liquid mixture.

The liquid mixture may then be thermally treated to reduce bacterial loads. For example, the liquid mixture may be rapidly heated to a temperature in the range of about 80° C. to about 110° C. for about 5 seconds to about 5 minutes. This may be carried out by steam injection or by heat exchanger; for example a plate heat exchanger.

The liquid mixture may then be cooled to about 60° C. to about 85° C.; for example by flash cooling. The liquid mixture may then be homogenised; for example in two stages at about 7 MPa to about 40 MPa in the first stage and about 2 MPa to about 14 MPa in the second stage. The homogenised mixture may then be further cooled to add any heat sensitive components such as vitamins and minerals. The pH and solids content of the homogenised mixture is conveniently standardised at this point.

The homogenised mixture can be transferred to a suitable drying apparatus such as a spray drier or freeze drier and converted to powder. The powder should have a moisture content of less than about 3% by weight.

If it is desired, probiotic(s) can be added, they may be cultured according to any suitable method and prepared for addition to the infant formula by freeze-drying or spray-drying for example. Alternatively, bacterial preparations can be bought from specialist suppliers such as Christian Hansen and Morinaga already prepared in a suitable form for addition to food products such as infant formula. Such bacterial preparations may be added to the gender specific powdered infant formula by dry mixing.

The gender specific synthetic nutritional compositions of the invention may also be prepared from a gender neutral synthetic nutritional composition in a method comprising; measuring out an appropriate amount of said gender neutral synthetic nutritional composition and mixing it with an additive and/or a diluent e.g. glycine and/or water so as to arrive at a gender specific synthetic nutritional composition in accordance with the invention.

The additive may be a gender specific additive comprising glycine in a particular concentration so that when mixed with the gender neutral synthetic nutritional composition, and optionally a diluent, the resulting mixture is a gender specific synthetic nutritional composition in accordance with the invention.

The gender neutral synthetic nutritional composition can be prepared by methods well known in the art for the type of composition in question e.g. as laid out above for infant formula.

The term “gender neutral” as used herein is synonymous with unisex.

One or more of the gender specific synthetic nutritional compositions of the invention can be included in a nutritional system.

The term “nutritional system” as used herein refers to a collection of more than one synthetic nutritional composition advertised or sold as part of the same product range e.g. a collection of infant formulas sold under the same brand and adapted/tailored to the nutritional needs of infants of differing ages and/or genders and/or delivered by different methods e.g. C-section. The synthetic nutritional compositions making up the nutritional system may be packaged individually e.g. in capsules or boxes. Said packages can be sold individually, grouped together e.g. wrapped by plastic film or combined in a box, or in a combination of these two ways. The nutritional system may also comprise synthetic nutritional compositions for children older than 12 months.

In a further aspect of the present invention there is provided a nutritional system comprising a gender specific synthetic nutritional composition of the invention.

In an embodiment the nutritional system comprises a gender specific synthetic nutritional composition for a male infant and a gender specific synthetic nutritional composition for a female infant wherein said male and female gender specific synthetic nutritional compositions are for infants of the same age and wherein if said gender specific synthetic nutritional compositions are for infants of 1 to 2 months of age the concentration of glycine in said gender specific synthetic nutritional composition for a female infant is higher than in said gender specific synthetic nutritional composition for a male infant, and if said gender specific synthetic nutritional compositions are for infants of up to 1 month of age, or older than 2 months of age the concentration of glycine in said gender specific synthetic nutritional composition for a male infant is higher than in said gender specific synthetic nutritional composition for a female infant.

The concentration of glycine in said female gender synthetic nutritional compositions for infants of 1 to 2 months of age may be higher by any amount.

The concentration of glycine in said male gender synthetic nutritional compositions for infants of up to 1 month of age, or older than 2 months of age may be higher by any amount.

In an embodiment the nutritional system comprises a gender specific synthetic nutritional composition for a male infant of 1 to 2 months of age, and a gender specific synthetic nutritional composition for a female infant of 1 to 2 months of age, wherein the concentration of glycine in said female gender specific synthetic nutritional composition is higher than the glycine concentration of said male gender specific synthetic nutritional composition.

In an embodiment said female gender specific synthetic nutritional composition comprises 1 to 27, 3 to 15, 1.5 to 9.5, 1.5 to 3.6 mg/100 mL more glycine than the male gender specific synthetic nutritional composition.

In an embodiment the nutritional system comprises a gender specific synthetic nutritional composition for a male infant of up to 1 month of age, and a gender specific synthetic nutritional composition for a female infant up to 1 months of age wherein, the concentration of glycine in said male gender specific synthetic nutritional composition is higher than the glycine concentration of said female gender specific synthetic nutritional composition.

In an embodiment said male gender specific synthetic nutritional composition comprises 2 to 139, 2.5 to 106, 2 to 4, 2 to 3.6 mg/100 mL more glycine than the male gender specific synthetic nutritional composition.

In an embodiment the nutritional system comprises a gender specific synthetic nutritional composition for a male infant of older than 2 months of age, and a gender specific synthetic nutritional composition for a female infant of older than 2 months of age, wherein the concentration of glycine in said male gender specific synthetic nutritional composition is higher than the glycine concentration of said female gender specific synthetic nutritional composition.

In an embodiment said male gender specific synthetic nutritional composition comprises 0.01 to 62, 1 to 53, 1.5 to 13, 1.5 to 3, 1.6 to 2.5 mg/100 mL more glycine than the female gender specific synthetic nutritional composition.

Statistical analysis of the results of the cross-sectional study described herein indicated that gender differences in the glycine concentration of HM at 1 to 2 months postpartum may be significant.

Accordingly, it may be that the nutritional systems of the invention only comprise gender specific synthetic nutritional compositions of the invention for infants of 1 to 2 months of age.

In another embodiment the nutritional system further comprises gender neutral synthetic nutritional compositions for infants up to 1 month of age and/or infants older than 2 months of age.

In another embodiment the nutritional system further comprises gender specific synthetic nutritional compositions for infants of up to 1 month of age, or older than 2 months of age, wherein the glycine concentration does not differ by gender.

The nutritional system may further comprise nutritional compositions for children older than 12 months.

Gender specific synthetic nutritional compositions according to the invention are particularly suitable for use in a method of preparing single servings of infant formula using capsules, each capsule of which contains a unit dose of a synthetic nutritional composition e.g. a gender specific synthetic nutritional composition in a concentrated form, and which is equipped with opening means contained within the capsule to permit draining of the reconstituted synthetic nutritional composition directly from the capsule into a receiving vessel such as a baby bottle. Such a method is described in WO2006/077259.

The different synthetic nutritional compositions, including the gender specific synthetic nutritional compositions of the invention, may be packed into individual capsules and presented to the consumer in multipacks containing a sufficient number of capsules to meet the requirements of an infant of a particular age or age range, for one week for example. Suitable capsule constructions are disclosed in WO2003/059778.

The different synthetic nutritional compositions, including gender specific and gender neutral synthetic nutritional compositions, which may be comprised within a nutrition system, may be packed into individual capsules and presented to the consumer in multipacks containing a sufficient number of capsules to meet the requirements of an infant of a particular age or range for one week for example. Suitable capsule constructions are disclosed in WO2003/059778.

The capsules can contain the synthetic nutritional compositions, (gender specific and gender neutral) in the form of powders or concentrated liquids in both cases for reconstitution by an appropriate amount of water. Both the composition and the quantity of infant formula in the capsules may vary according to the gender and/or age of the infant. If necessary, different sizes of capsules may be provided for the preparation of infant formulas for infants of different genders and/or ages.

Because HM is the gold standard when it comes to infant nutrition, and because the glycine concentration of the gender specific synthetic nutritional compositions of the invention better reflect the glycine concentration found in HM at the corresponding lactation stage for mothers of infants of the corresponding gender, they, and the nutritional systems comprising them, may be used to provide an optimum amount of glycine to an infant and to help ensure optimum growth and development.

Optimum growth and development may be immediate and/or long term. Long term may only be evident in months or years e.g. 6 months, 9 months, 12 months, 5 years, 10 years, or 20 years.

In another aspect of the present invention there is provided a gender specific synthetic nutritional composition of the invention for use to treat, prevent or mitigate sub optimal growth e.g. obesity of an infant.

The gender specific synthetic nutritional compositions of the invention may provide an optimum amount of glycine to an infant, in particular to an infant up to 1 months of age, 1 to 2 months of age, and older than 2 months of age.

The nutritional system may for example provide an optimum amount of glycine to an infant, in particular for an infant up to 12, 11, 10, 9, 8, 7, 6, 5, 4, 3, 2, 1 months of age and/or up to 2 weeks of age.

In another aspect of the present invention there is provided a method for providing an optimum amount of glycine to an infant comprising:
a) Optionally preparing a gender specific synthetic nutritional composition of the invention from a gender-neutral synthetic nutritional composition;
b) Feeding a gender specific synthetic nutritional composition according to the invention to an infant, in particular an infant of the corresponding gender and age.

As stated herein. The gender specific synthetic nutritional compositions may be prepared from gender neutral synthetic nutritional compositions. Accordingly, in another aspect of the present invention there is provided a kit for providing an optimized amount of glycine to an infant, in particular an infant up to 1 month of age, 1 to 2 months of age and/or older than 2 months of age, the kit comprising:
a) A gender neutral synthetic nutritional composition
b) A label indicating dosage requirements for an infant so as to arrive at a gender specific nutritional composition in accordance with the invention.

The dosage requirements may be with respect to the quantity of the gender neutral synthetic nutritional employed and/or consumption frequency e.g. 4 times per day.

It should be appreciated that all features of the present invention disclosed herein can be freely combined and that variations and modifications may be made without departing from the scope of the invention as defined in the claims. Furthermore, where known equivalents exist to specific features, such equivalents are incorporated as if specifically referred to in this specification.

There now follows a series of non-limiting examples that serve to illustrate the invention.

### EXAMPLES

### Example 1

The concentration of glycine in HM samples collected from mothers to either male or female infants was analysed at various stages postpartum. The HM samples were collected as part of a cross sectional survey of HM. The study criteria is set out below:

### Study Population

Number of subjects

Total 540 healthy subjects were enrolled, allowing a drop-out rate of 10 percent. They were comprised of:
480 Lactating mothers in 3 cities (Beijing, Suzhou and Guangzhou)
30 mothers per city for each of the 5 time points (5 toll days, 2 weeks to 1 month, 1 to 2 months, 2 to 4 months and, 4 to 8 months)

### Inclusion/Exclusion Criteria

Inclusion: Healthy Chinese lactating mothers without history of acute and chronic diseases; exclusively breast feeding mothers during 4 months after delivery were enrolled.
Exclusion: Chinese lactating mothers having history of psychopathic tendencies and having no dietary memory.

The concentration of glycine in the HM samples collected as part of the above detailed study were analyzed using firstly acid hydrolysis in 6 M hydrochloric acid at 110° C. for 22 hrs with phenol antioxidant in the absence of oxygen to liberate all protein-bound amino acids, followed secondly by high-sensitivity amino acid analysis using derivatisation with o-Phthalaldehyde (OPA) and 9-Fluorenylmethyl Chloroformate (FMOC), and fluorescence detection (Blankenship D. T. et al. (1989) Analytical Biochemistry 178: 227).

The results of the compositional analysis of the HM survey, with respect to the concentration of glycine are shown in tables I.

TABLE I

| | | Glycine Concentration mg/100 mL | | | | | | | | | | | |
|---|---|---|---|---|---|---|---|---|---|---|---|---|---|
| | | Female | | | | | | Male | | | | | |
| Stage | | N | Min | Mean | Max | SD | Median | N | Min | Mean | Max | SD | Median |
| 5-11 | days | 39 | 16.15 | 49.02 | 151.14 | 23.76 | 45.42 | 50 | 20.50 | 52.09 | 154.80 | 22.30 | 47.82 |
| 12-30 | days | 37 | 25.55 | 37.13 | 89.60 | 13.84 | 33.60 | 48 | 18.70 | 40.72 | 156.20 | 20.40 | 36.20 |
| 1-2 | months | 39 | 17.50 | 30.23 | 53.40 | 8.32 | 28.30 | 48 | 15.80 | 26.64 | 44.20 | 6.65 | 26.70 |
| 2-4 | months | 36 | 13.35 | 23.67 | 37 | 5.79 | 22.53 | 54 | 8.75 | 23.68 | 36.40 | 5.05 | 24.25 |
| 4-8 | months | 44 | 14.90 | 23.76 | 41.80 | 5.41 | 22.75 | 43 | 16.30 | 26.27 | 76.70 | 9.66 | 24.49 |

Statistical analysis: the results of the compositional analysis were then subject to a statistical analysis employing the following multiple regression model:

Log(Glycine)=B₀+B₁stage+B₂sex+B₃stage*sex+B₄delivery+B₅city

Age of infant is represented in the term stage. A logarithmic transformation was applied to glycine as it showed to be of log-Normal distribution according to a Box-Cox graphical assessment.

The different suffixes (B₀, B₁, B₂ . . . ) represent the different estimated slopes attached to the corresponding variable (stage, sex and/or their interaction).

Table II shows the estimates for timeframe differences along with the corresponding Pvalues.

The results of the Statistical analysis (statistical inference) are show in in table II.

TABLE II

| | | | | |
|---|---|---|---|---|
| Timeframe | Variable | Contrast | SE | Pvalue |

| | | | | | |
|---|---|---|---|---|---|
| 5-11 | days | Glycine | 0.929 | 1.064 | 0.23582140 |
| 12-30 | days | Glycine | 0.920 | 1.065 | 0.18585830 |
| 1-2 | months | Glycine | 1.137 | 1.064 | 0.03811783 |
| 2-4 | months | Glycine | 0.996 | 1.063 | 0.95008860 |
| 4-8 | months | Glycine | 0.930 | 1.064 | 0.23876515 |

Contrast refers to the estimated difference between male and female glycine concentrations via the ratio of their geometric means. The value 1.137 indicates that the glycine concentration for females are greater than males by around 14%.

A P-value inferior to 0.1 for a particular timeframe suggests that there is a statistically significant difference in the glycine content of HM produced at the specific timeframes indicated.

### Example 2

Examples of gender specific synthetic nutritional compositions (infant formulas) tailored to infants of 4 months of age or older are given in table III

TABLE III

| | Up to 1 months | | 1 to 2 months | | 2 months of | |
|---|---|---|---|---|---|---|
| | of age | | of age | | age and older | |
| | M | F | M | F | M | F |
| Ingredients | Per Liter | | Per Liter | | Per Liter | |
| Energy (kcal) | 670 | 670 | 670 | 670 | 630 | 630 |
| Protein (g) | 10.01 | 10.8 | 10.01 | 10.8 | 11.3 | 11.3 |
| Glycine (g) | 0.41 | 0.37 | 0.27 | 0.30 | 0.24 | 0.24 |
| Fat (g) | 35.7 | 35.7 | 35.7 | 35.7 | 31.446 | 31.458 |
| Linoleic acid (g) | 5.3 | 5.3 | 5.3 | 5.3 | 4.7 | 4.7 |
| α-Linolenic acid (mg) | 675 | 675 | 675 | 675 | 600 | 600 |
| Lactose (g) | 74.7 | 74.7 | 74.7 | 74.7 | 75 | 75 |
| Prebiotic (100% GOS) (g) | 4.3 | 4.3 | 4.3 | 4.3 | 4.0 | 4.0 |
| Minerals (g) | 2.5 | 2.5 | 2.5 | 2.5 | 2.3 | 2.3 |
| Na (mg) | 150 | 150 | 150 | 150 | 158 | 158 |
| K (mg) | 590 | 590 | 590 | 590 | 504 | 504 |
| Cl (mg) | 430 | 430 | 430 | 430 | 410 | 410 |
| Ca (mg) | 410 | 410 | 410 | 410 | 378 | 378 |
| P (mg) | 210 | 210 | 210 | 210 | 208 | 208 |
| Mg (mg) | 50 | 50 | 50 | 50 | 44 | 44 |
| Mn (μg) | 50 | 50 | 50 | 50 | 32 | 32 |
| Se (μg) | 13 | 13 | 13 | 13 | 19 | 19 |
| Vitamin A (μg RE) | 700 | 700 | 700 | 700 | 570 | 570 |
| Vitamin D (μg) | 10 | 10 | 10 | 10 | 9.5 | 9.5 |
| Vitamin E (mg TE) | 5.4 | 5.4 | 5.4 | 5.4 | 5.0 | 5.0 |
| Vitamin K1 (μg) | 54 | 54 | 54 | 54 | 50 | 50 |
| Vitamin C (mg) | 67 | 67 | 67 | 67 | 95 | 95 |
| Vitamin B1 (mg) | 0.47 | 0.47 | 0.47 | 0.47 | 0.6 | 0.6 |
| Vitamin B2 (mg) | 1 | 1 | 1 | 1 | 0.6 | 0.6 |
| Niacin (mg) | 6.7 | 6.7 | 6.7 | 6.7 | 3.2 | 3.2 |
| Vitamin B6 (mg) | 0.5 | 0.5 | 0.5 | 0.5 | 0.4 | 0.4 |
| Lactoferrin (bovine) g | 1 | 1 | 1 | 1 | 0.3 | 0.3 |
| Folic acid (μg) | 60 | 60 | 60 | 60 | 95 | 95 |
| Pantothenic acid (mg) | 3 | 3 | 3 | 3 | 5.0 | 5.0 |
| Vitamin B12 (μg) | 2 | 2 | 2 | 2 | 1.3 | 1.3 |
| Biotin (μg) | 15 | 15 | 15 | 15 | 12.6 | 12.6 |
| Choline (mg) | 67 | 67 | 67 | 67 | 95 | 95 |
| Fe (mg) | 8 | 8 | 8 | 8 | 6.3 | 6.3 |
| I (μg) | 100 | 100 | 100 | 100 | 95 | 95 |
| Cu (mg) | 0.4 | 0.4 | 0.4 | 0.4 | 0.4 | 0.4 |
| Zn (mg) | 5 | 5 | 5 | 5 | 5.7 | 5.7 |

### Example 3

An example of a nutritional system in accordance with the invention is given in table IV.

TABLE IV

| | Up to 1 | | | 2 months |
|---|---|---|---|---|
| | months | | | of age and |
| | of age | 1 to 2 months | | older |
| | Gender | of age | | Gender |
| | neutral | M | F | neutral |
| Ingredients | Per Liter | Per Liter | | Per Liter |
| Energy (kcal) | 670 | 670 | 670 | 630 |
| Protein (g) | 10.01 | 10.01 | 10.8 | 11.3 |
| Glycine (g) | 0.37 | 0.27 | 0.30 | 0.24 |
| Fat (g) | 35.7 | 35.7 | 35.7 | 31.446 |
| Linoleic acid (g) | 5.3 | 5.3 | 5.3 | 4.7 |
| α-Linolenic acid (mg) | 675 | 675 | 675 | 600 |
| Lactose (g) | 74.7 | 74.7 | 74.7 | 75 |
| Prebiotic (100% GOS) (g) | 4.3 | 4.3 | 4.3 | 4.0 |
| Minerals (g) | 2.5 | 2.5 | 2.5 | 2.3 |
| Na (mg) | 150 | 150 | 150 | 158 |
| K (mg) | 590 | 590 | 590 | 504 |
| Cl (mg) | 430 | 430 | 430 | 410 |
| Ca (mg) | 410 | 410 | 410 | 378 |
| P (mg) | 210 | 210 | 210 | 208 |
| Mg (mg) | 50 | 50 | 50 | 44 |
| Mn (μg) | 50 | 50 | 50 | 32 |
| Se (μg) | 13 | 13 | 13 | 19 |
| Vitamin A (μg RE) | 700 | 700 | 700 | 570 |
| Vitamin D (μg) | 10 | 10 | 10 | 9.5 |
| Vitamin E (mg TE) | 5.4 | 5.4 | 5.4 | 5.0 |
| Vitamin K1 (μg) | 54 | 54 | 54 | 50 |
| Vitamin C (mg) | 67 | 67 | 67 | 95 |
| Vitamin B1 (mg) | 0.47 | 0.47 | 0.47 | 0.6 |
| Vitamin B2 (mg) | 1 | 1 | 1 | 0.6 |
| Niacin (mg) | 6.7 | 6.7 | 6.7 | 3.2 |
| Vitamin B6 (mg) | 0.5 | 0.5 | 0.5 | 0.4 |
| Lactoferrin (bovine) g | 1 | 1 | 1 | 0.3 |
| Folic acid (μg) | 60 | 60 | 60 | 95 |
| Pantothenic acid (mg) | 3 | 3 | 3 | 5.0 |
| Vitamin B12 (μg) | 2 | 2 | 2 | 1.3 |
| Biotin (μg) | 15 | 15 | 15 | 12.6 |
| Choline (mg) | 67 | 67 | 67 | 95 |
| Fe (mg) | 8 | 8 | 8 | 6.3 |
| I (μg) | 100 | 100 | 100 | 95 |
| Cu (mg) | 0.4 | 0.4 | 0.4 | 0.4 |
| Zn (mg) | 5 | 5 | 5 | 5.7 |

1. A Gender specific synthetic nutritional composition tailored for an infant comprising glycine in a concentration reflecting the concentration found in human milk produced for an infant of the same gender at the corresponding lactation stage.

2. A gender specific synthetic nutritional composition according to claim 1 wherein, the composition is tailored for an infant of an age selected from the group consisting of up to 1 month of age, 1 to 2 months of age, and 2 months of age or older, and wherein if the concentration of glycine is tailored to a male infant of up to 1 month of age it is within the range of 18 to 157 mg/100 mL and, if the concentration of glycine is tailored to a female infant of up to 1 month of age it is within the range of 16 to 152 mg/100 mL; if the concentration of glycine is tailored to a male infant of 1 to 2 months of age it is within the range of 15 to 45 mg/100 mL and, if the concentration of glycine is tailored to a female infant of 1 to 2 months of age it is within the range of 17 to 54 mg/100 mL; and if the concentration of glycine is tailored to a male infant of 2 months of age or older it is within the range of 8 to 77 mg/100 mL and, if the concentration of glycine is tailored to a female infant of 2 months of age or older it is within the range of 13 to 42 mg/100 mL.

3. A gender specific synthetic nutritional composition according to claim 1 wherein, the gender specific synthetic nutritional composition is selected from the group consisting of: infant formula, and a composition for infants that is intended to be added to or diluted with human milk.

4. (canceled)

5. A nutritional system comprising a gender specific synthetic nutritional composition tailored for an infant comprising glycine in a concentration reflecting the concentration found in human milk produced for an infant of the same gender at the corresponding lactation stage.

6. A nutritional system according to claim 5 comprising a gender specific synthetic nutritional composition for a male infant and, one gender specific nutritional composition for a female infant wherein the male and female gender specific synthetic nutritional compositions are for infants of 1 to 2 months of age, and wherein the concentration of glycine in the gender specific synthetic nutritional composition for a female infant is higher than in the gender specific synthetic nutritional composition for a male infant.

7. A nutritional system according to claim 5 comprising a gender specific synthetic nutritional composition for a male infant and, one gender specific nutritional composition for a female infant wherein the male and female gender specific synthetic nutritional compositions are for infants of the same age and selected from the group consisting of up to 1 month of age and older than 2 months of age, and wherein the concentration of glycine in said gender specific synthetic nutritional composition for a male infant is higher than in said gender specific synthetic nutritional composition for a female infant.

8. A nutritional system according to claim 5 wherein if the gender specific synthetic nutritional compositions are for infants of up to 1 month of age the male gender specific synthetic nutritional composition comprises 2 to 139 mg/100 mL more glycine than the female gender specific synthetic nutritional composition; if the gender specific synthetic nutritional compositions are for infants of 1 to 2 months of age the female gender specific synthetic nutritional composition comprises 1 to 27 mg/100 mL more glycine than the male gender specific synthetic nutritional composition; and if the gender specific synthetic nutritional compositions are for infants of 2 months of age or older the male gender specific synthetic nutritional composition comprises 0.01 to 62 mg/100 mL more glycine than the female gender specific synthetic nutritional composition.

9. A nutritional system according to claim 5 comprising a gender neutral synthetic nutritional composition and/or gender specific synthetic nutritional compositions for infants wherein, the concentration of glycine in the gender specific synthetic nutritional compositions does not differ by gender for infants of the same age.

10. A nutritional system according to claim 9 wherein the nutritional system only comprises a gender specific synthetic nutritional composition for an infant of 1 to 2 months of age, and wherein the nutritional system comprises for infants up to 1 month of age and/or 2 months of age or older, a gender neutral synthetic nutritional composition and/or gender specific synthetic nutritional compositions wherein the concentration of glycine does not differ by gender.

11-12. (canceled)

13. A method for providing an optimum amount of glycine to an infant and preventing or mitigating sub optimal growth and development comprising:
preparing a gender specific synthetic nutritional composition tailored for an infant comprising glycine in a concentration reflecting the concentration found in human milk produced for an infant of the same gender at the corresponding lactation stage; and
feeding a gender specific synthetic nutritional composition to an infant.

14-15. (canceled)
